(19) United States
(12) Patent Application Publication
(10) Pub. No.: US 2019/0306235 A1
(43) Pub. Date: Oct. 3, 2019

(54) Private Blockchain With Decentralized External Gateway

(71) Applicant: MakeCents LLC, Providence, RI (US)

(72) Inventors: Thomas Veale, Brooklyn, NY (US); Bo Yao, West New York, NJ (US); Prageeth Nuwan Kumara Maha Badalge, Upper Saddle River, NJ (US); Sushanth Krishnaswamy, Brooklyn, NY (US); Yuxuan Zhang, Jersey City, NJ (US)

(21) Appl. No.: 16/366,655

(22) Filed: Mar. 27, 2019

Related U.S. Application Data
(60) Provisional application No. 62/648,696, filed on Mar. 27, 2018.

(51) Int. Cl. H04L 29/08; H04L 9/32; H04L 9/14; G06F 16/18

(52) U.S. Cl. CPC H04L 67/1078; H04L 9/3247; H04L 9/3236; H04L 2209/56; G06F 16/1805; H04L 2209/38; H04L 9/14

(57) ABSTRACT

A system providing a decentralized gateway for external entry into a private blockchain holding where the private blockchain and the gateway use different processors in that a first processor is used to reach consensus on public to private transactions as compared to a second processor used to reach consensus on private to private transactions on the peer to peer network. The manner of reaching consensus for both processors may be the same or different, but different sources of data are used.

### FIELD OF THE INVENTION

The following relates to a cryptographic protocol which provides added security to reduce the possibility of loss or double spend in private blockchain protocols based upon external assets.

### BACKGROUND OF THE INVENTION

Blockchain based protocols for cryptographic and crypto currencies have become more and more widely used, but suffer issues in terms of how users interact with those public blockchains. The idea behind a blockchain is that the ownership history behind a particular cryptographic token is public and known and can be inspected by anyone. Generally, this is referred to a developing a consensus in the manner that since the blockchain ledger is public, everyone can see a token moved from A to B and B to C and various computerized proofs are accomplished to create unalterable histories behind these tokens. Essentially, the cost and computing power necessary to cheat the system is so great that it becomes impractical when considering that working in a trustworthy manner within the system has a much easier to achieve and thus profitable award as compared to illicit or fraud motivated goals.

However, a serious problem in usability exists in that the average person does not have sophisticated computer skills or abilities in order to run and utilize the necessary hardware and software to acquire and trade in cryptographic tokens. Rather, the average user relies on third party companies to have an infrastructure and platform/software available to let the user acquire cryptographic assets in a wallet or account. But, this structure fundamentally alters and fails to achieve the basic goal of the blockchain protocol in that the idea of the blockchain protocol was to have a decentralized way of owning tokens that does not rely upon third parties as the trusted intermediary.

Other issues with many blockchain tokens such as bitcoin, ethereum, litecoin and others is that the assets can fluctuate widely in value and thus often cannot operate as a substitute for cryptocurrencies.

### SUMMARY OF THE INVENTION

Thus, it is an object of the present invention to provide for a peer-to-peer stable value token which does not rely upon third parties to prevent double spend.

It is further an object of the invention to provide a distributed verification system to fund peer-to-peer stable value tokens and networks with other assets of value such as tokens or others without requiring particular third parties to prevent double spend.

It is a further object of the invention to provide for faster verification and transfer of funds in a stable value token environment to enable cryptographic assets to be used for day to day transfers of value while having a decentralized reserve backing the tokens.

These and other objects are achieved by providing a system providing a private blockchain with decentralized external gateway into the private blockchain. The system includes a plurality of computer nodes in communication over a private network and executing one or more software packages and keeping a ledger. A first set of the plurality of computer nodes being validator nodes and executing a validator software package having at least one of first and second processor protocol software packages. The system provides a second set of the plurality of computer nodes, a first set of tokens and a second set of tokens which are derived from said first set of tokens. At least one of the plurality of nodes transmitting a request to the private network to transfer one or more tokens or parts thereof from a public network via a first processor protocol, the request transmitted to two or more of the first set of the plurality of computer nodes. At least one of the two or more of the first set of the plurality of computer nodes validating the transfer and updating the ledger to generate a confirmation. Remaining ones of the two or more of the first set of the plurality of computer nodes validating the confirmation in the ledger wherein the ledger is updated by validator nodes such that the at least one of the plurality of nodes which transmitted the request shows at least some of the first set of tokens based on the transfer. A second processor protocol receives a transfer request via the private network from at least one of the plurality of nodes to convert at least some of the first set of tokens into at least some of said second set of tokens.

In certain aspects the first processor protocol receives data from both external and internal sources of data, the external source of data being a public blockchain ledger. In other aspects the second processor protocol receives data only from internal sources of data. In still other aspects the two or more of the first set of the plurality of computer nodes are selected based on a time period having not expired.

In certain aspects at least one of the two or more of the first set of the plurality of computer nodes is a fastest of the two or more of the first set of the plurality of computer nodes to validate the transfer. In certain aspects the fastest of the two or more of the first set of the plurality of computer nodes receives a fee in the form of a token selected from the first set of tokens or the second set of tokens for validating the transfer. In other aspects the one or more validation software packages for the first set of the plurality of nodes including software for supporting the first processor protocol and the second processor protocol. In certain aspects the one or more validation software packages for the second set of the plurality of nodes includes software for supporting the second processor protocol and not for supporting the first processor protocol.

In other aspects the first processor protocol utilizes data from the private and public network for creation of one or more or part thereof of the first set of tokens and the second processor protocol utilizes data from only the private network for creation of one or more of or part thereof of the second set of tokens.

Other objects are achieved by providing a node with a validation software package for a decentralized gateway to a private blockchain. A first node is a computer executing a validator software package having at least one of first and second processor protocol software packages. The first node receiving a request to transfer one or more tokens or parts thereof from a public network via a first processor protocol. The first node validates the request and the transfer source to generate and generating a confirmation. The first node compares the confirmation to a ledger containing a plurality of hashes to determine if the confirmation contains a hash present on the ledger. If the confirmation contains a hash not present on the ledger, the first node updating the ledger with the confirmation. If the confirmation a hash present on the ledger, the first node verifying the hash present on the ledger with the confirmation generated. Upon the ledger containing the hash associated with the confirmation, one node associated with the request being further indicated as having a root token requested by the request. The first node receives a request via a private network to validate a conversion of root token to leaf token and via a second processor protocol, the first node generating a confirmation.

In certain aspects the first processor protocol utilizes data from the private and public network for creation of one or more or part thereof of the first set of tokens and the second processor protocol utilizes data from only the private network for creation of one or more of or part thereof of the second set of tokens. In certain aspects the first processor protocol receives data from both external and internal sources of data, the external source of data being a public blockchain ledger. In other aspects the second processor protocol receives data only from internal sources of data.

In other aspects, prior to the first node validating the request, the first node determines if a time period is active such that the first node is permissioned to validate the request. In certain aspects if the time period is not active, the first node transfers the request to a different node for which the time period is active. In certain aspects if the time period is active, the first node generates the confirmation. In certain aspects the request is transferred to the different node via another node.

Other objects are achieved by a method of providing a decentralized gateway to a private blockchain comprising one or more of the steps of: providing a plurality of computer nodes in communication with each other over a private network, the plurality of computer nodes executing one or more software packages and keeping a ledger; a first set of the plurality of computer nodes being validation nodes and receiving requests to convert source tokens to root tokens; the first set of the plurality of computer nodes generating confirmations for updating a ledger wherein a first one of the first set of the plurality of computer nodes to generate the confirmation, modifies the ledger with the confirmation and others of the first set of the plurality of computer nodes verify the modification; two or more of the first set of the plurality of computer nodes receiving a request to convert root tokens to leaf tokens and the two or more of the first set of the plurality of computer nodes generating a confirmation which modifies the ledger.

In certain aspects the first set of the plurality of computer nodes and the two or more of the first set of the plurality of computer nodes include different ones of the plurality of computer nodes.

### BRIEF DESCRIPTION OF THE DRAWINGS

FIG. 1 is a functional flow diagram of the present invention.

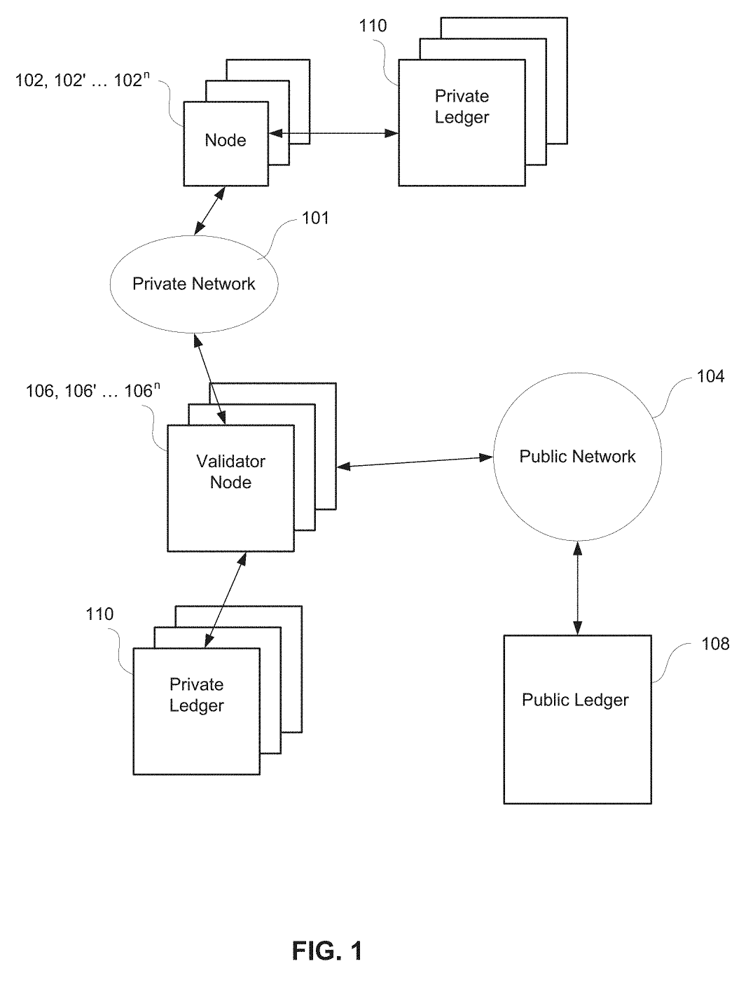

FIG. 2 is a flow diagram of features of FIG. 1.

FIG. 3 is a functional flow diagram of certain features of FIG. 1.

FIG. 4 is a functional flow diagram showing “MINT” and “MELT” functions described herein.

FIG. 5 is a functional flow diagram showing a liquidity process.

### DETAILED DESCRIPTION OF THE INVENTION

Cryptocurrencies have come a long way since the inception of Bitcoin (cite bitcoin) in 2008. The technology is a synthesis of a few older concepts including digital signatures, peer-to-peer communications, authenticated data structures, and proofs-of-work. Amazingly, the resulting protocol sidesteps the long standing requirement for a trusted setup or PKI while still guaranteeing security properties like availability and integrity. Gathering interest by academia and industry alike has led quickly to tangible advancements as seen in Ethereum, an expressive compute platform for executing arbitrary smart contracts and ZCash, a variant of Bitcoin focused on privacy. Speculators have since looked to back a myriad of variants often fueled by the flourishing and sometimes unscrupulous initial coin covering (ICO) eco-system. However, there remains one major problem to be solved: how do we use these cryptocurrencies as money in day to day life? Mobile payment solutions are already available around the world. These mobile payments live by and large on the old rails that come with egregious fees and settlement times. How long until you are able to use a blockchain based tender to buy a coffee on the corner? The platform provided herein is a fully equipped payments network, verification system, and merchant ecosystem that enables faster and less expensive payment processing while providing improved methods and system architecture for using distributed ledgers and decentralized computing.

The focus on the distributed computing, crypto-graphic, and systems architecture. The use of distributed ledger technology can solve the problem related to digital and mobile payments emphasized above. A distributed ledger or ledger is another term for a blockchain. It distributes a database of transactions to all parties in a network called nodes. There is no central administrator or centralized data storage. These blockchains are distributed in that the information in them is shared among potentially parties and is demonstrably identical on all nodes in the network. It is also immutable in that there is an unalterable history of all transactions that have updated the database, these updates come in batches called blocks that include hashes of previous blocks to make it easy to detect and prevent attempts to alter the history. Finally, blockchains are secure in that all changes performed by the transactions are signed by known identities.

In one embodiment, the present system uses Hyperledgers Sawtooth, a distributed ledger technology that stands apart from similar technologies in its separation of transaction semantics from syntax. This is very useful in that a single instance of Sawtooth is capable of processing many types of transaction without the need to alter the core system, which is responsible for building consensus. The features of a distributed ledger in conjunction with an agreed upon consensus mechanism provides a kind of trust among a group of nodes in the blockchain network. Consensus is the process of reaching agreement among a group of mutually distrusting parties. There are many algorithms for building consensus that guarantee different properties related to scalability, performance, consistency, threat models, and failure model. Most distributed ledgers operate with certain assumptions about Byzantine (malicious attackers seeking to subvert consensus) or rational attackers. Other requirements are largely determined by the application requirements. Financial applications, for instance, require high transaction throughput with a relatively small group of participating parties so that the validity and finality of each transaction can be ascertained very quickly. Some algorithms for achieving consensus with arbitrary faults generally require some form of voting among a known set of participants. Two general approaches have been proposed. The first, often referred to as Nakamoto consensus, elects a leader through a sort of random lottery of sorts. The leader then proposes a block that may be added to a chain of previously committed blocks. In Bitcoin, the first participant to successfully solve a cryptographic search puzzle, called a proof-of-work, wins the leader-election lottery. The elected leader broadcasts the new block to the rest of the participants who implicitly vote to accept the block by adding it to a chain of accepted blocks and proposing subsequent transaction blocks that build on top of that newly extended chain.

The second approach is based on traditional Byzantine Fault Tolerance (BFT) algorithms and uses multiple rounds of explicit votes to achieve consensus. Ripple and Stellar developed consensus protocols that extend traditional BFT for open participation. Sawtooth uses the core concepts of consensus and isolates consensus from transaction semantics. The consensus interface supports plugging various consensus implementations, and perhaps most importantly, the consensus implementation may be changed throughout the lifecycle of the ledger through a transaction. We explore variants of a consensus protocol called proof of elapsed time (PoET).

Very briey, the state of Sawtooth's distributed ledger is represented as a Radix Merkle Tree, a copy-on-write data structure which stores successive node hashes from leaf-to-root upon any changes to the tree. In a given set of state transitions associated with a block we can generate a single root hash which points to that version of the tree. By including that root hash in a block, we can reach consensus on the expected version of the state in addition to consensus on the order of the chain of blocks. Any node that applies state transitions that results in a different hash is marked as invalid, and discarded. Nodes who process transactions are called validators. Modifications to state are performed by creating and applying transactions. A client creates a transaction and submits it to the validator. The validator applies the transaction which causes a change to state. Transactions are always wrapped inside of a batch. All transactions within a batch are committed to state together or not at all. Thus, batches are the atomic unit of state change. In Sawtooth, the set of possible transactions are defined by an extensible system called transaction families. Defining and implementing a new transaction family adds to the taxonomy of available transactions which can be applied. The state of each family is kept separate through namespaces across the global state, with 2²⁴ possible transaction families. Each family must be processed by a specialized transaction processor that programmatically decodes and validates transactions from that family.

An instance of Sawtooth is highly configurable in that the settings transaction family allows for hot switching the list of validators, system parameters like the number of transactions per block, or even the underlying consensus mechanism. The process of making changes to these settings are well defined by the processor, but the policy of deciding whom should be able to do it is not. To provide a utility to configure permissions in the ledger, an identity transaction family was devised so that roles could be assigned to certain players.

PoET Proof of Elapsed Time consensus method offers a solution to the byzantine generals problem and utilizes a trusted execution environment. At a high level PoET stochastically elects individual peers to execute requests at a given target rate. Individual peers sample an exponential distributed random variables and wait for an amount of time dictated by the sample. The peer with the smallest sample wins the election. Cheating is prevented through the use of a trusted execution environment, identity verification, and blacklisting based on asymmetric key cryptography, and an additional set of election policies. PoET essentially works as follows: 1. Every validator requests a wait time from an enclave (a trusted function). 2. The validator with the shortest wait time t for a particular transaction block is elected the leader. 3. The function which creates a timer for time t is guaranteed to have been created by the enclave. 4. Another function checks the timer to verify that the timer was created by the enclave. If the timer has expired, this function creates an attestation (viz. proof) that is used to verify that validator did not wait the allotted time before claiming the leadership role.

There are three general layers that the platform: commerce, exchange, and validation. We leverage the versatility of Sawtooth's transaction family processors to define different asset (and transactions) at each layer.

On the commerce layer or generally private blockchain layer, the intended audience in this layer are consumers and merchants. This is the public facing product and it manifests in mobile devices and as plugins to existing point of sale hardware. Entities that interact with this layer transact primarily in an asset called A leaf token (L). Balance, ownership, and other utilities are managed through the SmallBank transaction family. Access to this layer is achieved through a gateway. These gateways are authenticated through symmetric keys and the servers should be decentralized. Entities that wish to host these gateways register with a transaction batcher, an entity with permission to submit batches to validators for settlement. Batchers are best explained below in the exchange layer.

The exchange is another layer which supports the first, by providing merchants and their associates a means to generate and modulate the supply of L through a gateway or bridge to an external blockchain or external data. In general, we expect entities in the exchange to represent existing trusted members of the economy or financial institutions, that utilize the old rails to keep a one to one tether of L:USD (or R:USD). This is achieved thru the introduction of a type of asset called a root token (R). R behaves a lot like bullion, it is bought and sold on an internal marketplace and may be taken to mint and converted to L thru a minting smart contract. There can be a number of variants or types of L which are accepted generally across the private network or some which are specific to certain categories/classes of nodes. For example, a “McDonalds Coin” useable only at McDonalds restaurants could be created as a type of leaf token minted from root tokens of McDonalds. This mechanism to mint, burn, exchange, and other utilities are realized thru the Seth transaction family, which provides access to the Ethereum virtual machine (EVM) from within sawtooth. The main idea here is that merchants that need to replenish their supply of L will transfer USD or other asset receive an equivalent amount of R (which is minted to L). Exchange entities act as batcher for gateway servers. This is a built in mechanism of Sawtooth, but is useful to segregate direct access from gateway providers to validators. This adds an important layer of security to the system because in the case of a corrupted gateway, the number of compromised commerce accounts is at most those controlled by the gateway.

The final layer is responsible for the validation and processing of the transactions described in the previous two layers. Entities who possess some portion the root assets may register to become a validator. To become a validator, a hopeful stakeholder will submit a validator registry transaction including a proof of stake.

There are existing attempts to stabilize cryptocurrencies. The first is perhaps USD Tether. As it sounds, these tokens are tethered one to one to the U.S. Dollar. Balances and token generation is achieved through the Omni layer, an extension to the Bitcoin blockchain that enables a more expressive application layer. This is achieved by pegging updates to the Omni layer through transactions that included commitments to the Bitcoin network. These commitments in Tether are meant to represent a proof of reserves which is supposed to match the number of tethered dollars represented. At the time of writing, tether has come under heavy scrutiny about their actual reserves of cash are difficult to track.

The present system provides a distributed validator/processor which makes public through the public ledger how the reserves of value are brought into the private network to create the R and L tokens.

The commerce layer is focused on merchant ecosystem development. The network takes a merchant first approach, unlike many other perspective stable coins. The solution is for merchants that see high volumes of customers in the fast service retailer space (i.e., fast-food, grocery, gas-station, convenience, etc.). The majority of transactions under $10 are made in cash. The system offers for these merchants number of advantages

Handling of cash is reduced in general: a. no time spent counting change; b. all change is exact, no chance over/under paying the customer; c. less loss/theft of bills; Clear transaction history of transactions: a. transparency of a. clear and time ordered list of cash in; b. access to cash data; c. possibility of personalized advertisements;

Old Rail payments: a. money movement happen in seconds as opposed to several days you experience in credit and debit cards. b. zero fees for processing payments. c. the money actually moves when we show it as committed; At the same time consumers can track their spending, save time, access to itemized receipts, and their change is securely stored right in their phone pocket.

The commerce layer relies heavily on merchant adoption. The challenge here is integration with older point of sale systems. In this regard, SDK's for various languages are provided that make this process as simple as possible. In these SDK's are key management, request building, and notification utilities. The essence of this system is to provide merchants and users this kind of experience. The commerce layer is implemented in the client-server model. Servers communicate with the other platform layers as well as serve requests from clients (PoS and mobile devices), while clients communicate via side channels, such as through QR codes, NFC, or Bar Codes. This API provides a common interface for user and transaction related services. Access is restricted through symmetric keys that use message authentication codes. To mitigate malfeasance, a number of layers are in place between any given API server and the actual blockchain. This is achieved through the separation of transaction creation from the batching process. Transaction requests originate from either the PoS Terminal or from a mobile device, which are built locally and then submitted to an API. Each API server generates a pair of keys and registers with a batcher. This enables a sort of filter or vetting process to transactions, a necessity for any digital payments solution to meet regulatory requirements (i.e., AML, Fraud Detection, Rate limiting).

As transaction requests submitted to the API are serialized into a Transaction protobuf and signed with the API's private key. Transaction will include the dependencies in them that makes for atomic transfers of value. The transaction will specify a batcher intended to batch the transaction. This batcher might be a public service hosted by the network, or perhaps one specified by the merchant. Batcher's can just batch the transactions they receive or run them against a set of rules. For instance, no transaction dispensing change can exceed 9999L. A batcher serializes transactions they have vetted into a Batch protobuf and apply their signature, then push that batch up to the validation layer.

A network such as lightening network or raiden can be executed instead of the API layer to provide stronger security guarantees and correctness at the commerce layer. This arises some other issues in key pairs storage etc. OAuth might be a more appropriate solution then. E.g One family per merchant and aggregate these. The database is going to be sharded otherwise on an on demand type authentication. The atomic unit of change to the global state maintained in Sawtooth are through a data structure called batches. Batches wrap one or more transactions, which specify the intended batcher's public key. Batcher behave much like gateways in the old rails, with the exception that merchant partners are expected to run their own batcher or use a public one. Batcher register with Sawtooth's identity service with their public keys

The exchange is a mechanism to settle real world account requirements between merchants, banks, and their customers. This problem is non-trivial as correctness of exchange between L (or R) and USD must be exact. A solution would be a direct swap between USD and L, but there are issues with such a direct exchange. For instance, how do I verify that there is really dollars in an account? Moreover, money in banks (and particularly between them) moves rather slowly. The processes that move these can be canceled. The solution provided a hybrid exchange system which uses a number of smart contracts that interface minimally with the old rails. This layer of the platform is permissioned, and geared towards trusted entities (i.e., banks, credit unions, etc.) and their merchant partners that have passed KYC, AML, and other regulatory checks.

The commerce layer improves existing payments systems, and the validation layer adds fairness, transparency, and traceability. The exchange exists to support early adopters of the commerce layer to source liquidity. It provides merchants with a smart contract platform and legal framework to exchange L for Fiat and vice versa through a network of trusted parties and an internal virtual commodity we call root tokens (R). Merchants source liquidity between Fiat and L by buying and selling R. R is useful to merchants because they can mint gold into L. A merchant that needs Fiat currency may melt a sum of L into an equal value of R. R may be sold to a trusted party in exchange for a bank transfer of Fiat to the merchant. The opposite direction, where a merchant needs L is achieved in a similar fashion. The merchant transfers Fiat currency along the old rails to an entity with R. Incentives (fees) are in place throughout this process to encourage participants in sourcing liquidity. Some reasons why this approach is desirable: (1) Generation of L is limited to entities that can acquire R (trusted and verified parties). (2) This satisfies our account requirements (3) Smart contracts are executed by the validation layer, which enables another layer of the system to audit and deny transactions in the permissioned layer. (4) Bank transfers in the \old rails” are slow, the exchange platform is equipped with time-locking, escrow, etc. (5) Decentralized reserve. The fiat tether of L is distributed among all the holders of R. (6) Merchants do not need to use a new bank. Here we introduce the internals of the exchange layer. A permissioned smart contract engine based on Hyperledger Burrow, which runs the Ethereum virtual machine is used

Example Algorithm 1 ERC20 Token Interface 1: function( ) totalSupply public constant returns (uint); 2: function( ) balanceOf(address tokenOwner) public constant returns (uint balance); 3: function( ) allowance(address tokenOwner, address Spender) public constant returns (uint remaining); 4: function( )transfer(address to, uint tokens) public returns (bool success); 5: function( )approve(address spender, uint tokens) public returns (bool success); 6: function( ) transferFrom(address from, uint tokens) public returns (bool success);

Supply R is issued in a ERC20 format. Mint and Melt Mint turns R into L, melt does the opposite. This is essentially an automated rate exchange. An entity that deposits one of the two assets into the contract will be able to withdraw an equal value of another asset at a rate. Balance is the balance of R in the contract. The exchange rate is the exchange rate of R to L. Both the mint and melt contract behave in a similar way, assets of one type are deposited into the contract, this earmarks a withdraw amount for the originator of the transaction. Melting is associated with a small rate fee structure to incentivize merchants to keep money in the system. Finally, retrieving a melted or minted asset is executed through their respective withdraw functions. Exchange Coordinates Banks and Merchants to source liquidity. Banks and merchants utilize traditional money moving techniques to settle accounts (i.e., wire transfer, cash deposits, or ACH). Before R is exchanged, it is stored in a time-locked exchange account.

Example Algorithm 2 Melt/Mint ERC20 tokens 1: function( ) Balance public constant returns (uint); 2: function( ) exchangeRate public constant returns (float); 3: function( ) meltFee public constant returns (float); 4: function( ) mint(address changer, uint gold) public returns (bool success); 5: function( ) melt(address changer, uint cash) public returns (bool success); 6: function( ) withdrawGold(uint gold) public returns (bool success); 7: function( ) withdrawCash(uint cash) public returns (bool success);

Example Algorithm 3 EtherDelta Style Dex 1: function( ) depositR(address token, uint amount) payable; 2: function( ) withdrawR(address token, uint amount); 3: function( )order(address goldGet, uint amountGet, address tokenGive, uint amountGive, uint expires,

Nonbank members of the exchange layer are thoroughly vetted in the standard anti money laundering (AML), know your customer (KYC), and sanctions requirements. The network provides a portal for completing this process. Upon a complete registration, the merchant or bank joins the exchange layer participants. The cryptography and smart contracts to these users will be as opaque as possible, to give a simple and consistent experience.

Integration for large merchant and bank partners will be made simple through well documented, industry standard SDKs in many popular programming languages. The SDK's will provide access to the smart contracts, transaction generation, registration tools, wallet functionality, and network communications.

The network is public, in that anyone may download Sawtooth and run a node, connecting to our seeds, and syncing their view. Becoming a validator requires certain processes described earlier. So, in a way there is a barrier to entry. The purpose here is to allow our network to expand and contract depending on the network load. This is a useful feature, as it allows for tuning of the network diameter through a PoET mining parameter we call Smin. Our modification to PoET essentially requires that each validator has some minimum amount of stake to participate as a validator. Doing so makes ownership of shares into a useful tool for identifying accounts. This modification allows for higher node scalability as well as the ability for the network to tune parameters to meet its needs. During periods of high stress, the minimum might be increased to reduce the network diameter; but relaxed when the throughput is less.

Consensus Nodes are identified through their public key and register with the network through the identity transaction processor. A registered node is a stakeholder (i.e., an account with some amount of stake, in the system is eligible to become a validator and contribute to the system

Validators are nodes who are responsible for collecting batches from the network, validating them against a set of protocol rules, and then appending them to the blockchain. The process of becoming a validator is as follows: a. Acquire some stake from exchange. b. Transfer stake onto the network. c. Register stake with other validators, including PoET information and proof of stake. d. After some number of rounds, the new validator may begin generating blocks. e. By the specifications of PoET, validators are only able to claim a specific number of blocks before they must re-register.

Mining rewards are paid out in L. Pools Because Smin might prove to be a significant barrier to entry in the future. Pooling contracts can be provided. This will allow users with a small amount of stake to earn rewards.

Referring now to the figures, process by which a decentralized network is used to enable the R and L tokens to be created is shown. The public network 104 can generally be considered a public blockchain such as Bitcoin, Litecoin or others utilizing a public ledger 108. The public network 104 can also refer to old rails such as ACH, and other traditional banking transfers which may be digitized. When a request is made from one of the nodes 102, 106 to acquire L or R tokens, a request is made to the validator nodes to validate that transfer and publish it to the private ledger to show a history/hash for the creation of the R token. In this manner, various consensus protocols can be used. In particular embodiments, the proof of elapsed time protocol is used as described previously. Here, the first validator node to generate a confirmation does so and updates the ledger 110. The remaining validator nodes who are elected under the elapsed time model will verify the confirmation in the ledger, resulting in the updated ledger being available. With non validator nodes 102, these will typically have a read only ledger which gets updated as transactions progress and are confirmed and validated. Once the R tokens are converted from the source (external tokens) through a first processor or the external protocol, L tokens can be minted through validators.

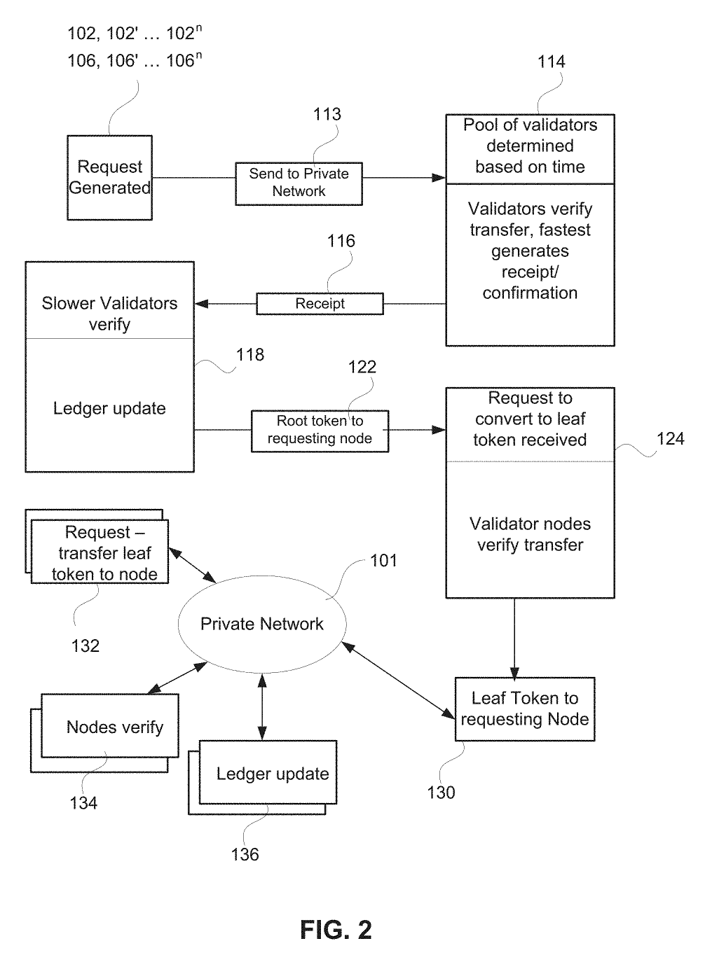

Referring to FIG. 2 the request is generated by one or more of the nodes 102/106 and sent to the private network 113. The pool of validators are determined 114 and the validators begin work on the confirmation. The first to confirm, generates the receipt/confirmation 116 which is updated to the ledger 118 while the slower validators verify that confirmation 116. The ledger is now updated in that the requesting node has the root token 122. Thus, the conversion from a source token to a root token utilizes both public data from the public networks/ledger 104/108 and internal data from the internal ledger/private network 110/101, but importantly, the transfer from source to root is done in a distributed fashion such that not one party is responsible for holding the value which provides liquidity and reserves to the system. This differs from typical ways of acquiring crypto assets through particular exchanges which hold the token for the actual owner much like a bank. There have been issues with these such as MtGox and more recently exchanges where the president/CEO passes away with passwords for assets which are now unable to be recovered. Thus, the distributed nature of the entry/gateway into the private blockchain enables ease of use for consumers and ensures that not one party is responsible for the R and/or L tokens having reserves and security protocols to back their value.

Next, leaf tokens are derived from root tokens to enable exchange of the leaf tokens between merchant and consumer or between consumers in a peer-to-peer style blockchain supported transfer protocol. Thus, a request from a node to convert to a leaf token is received 124 and the validator nodes verify the conversion/transfer. This may be done through a second (e.g internal) processor protocol which operates separately from the processor protocol that receives both internal and external data. This second processor protocol would differ in that it only receives internal data on the various transfers/hashes for the tokens being converted. This second processor can be used for the R to L conversion (mint/melt) or optionally the first processor can be used. When the R to L conversion happens, the appropriate hash on the ledger is made to prevent duplicate conversion of the same R token into additional L. For the L to L (peer-to-peer/commerce) transfer/exchanges, the second processor would be used and the private ledger 110 would contain the various hashes for the L tokens and as L tokens are destroyed so a user can cash out, the ledger 110 would be updated accordingly to prevent double spend of the now destroyed token. Within the private network 101, the request 132, verification 134 and ledger update 136 is handled using a consensus protocol. In one embodiment, the proof of elapsed time protocol is used. Fundamentally, this enables the L tokens and variants of L tokens to be exchanged within the private network.

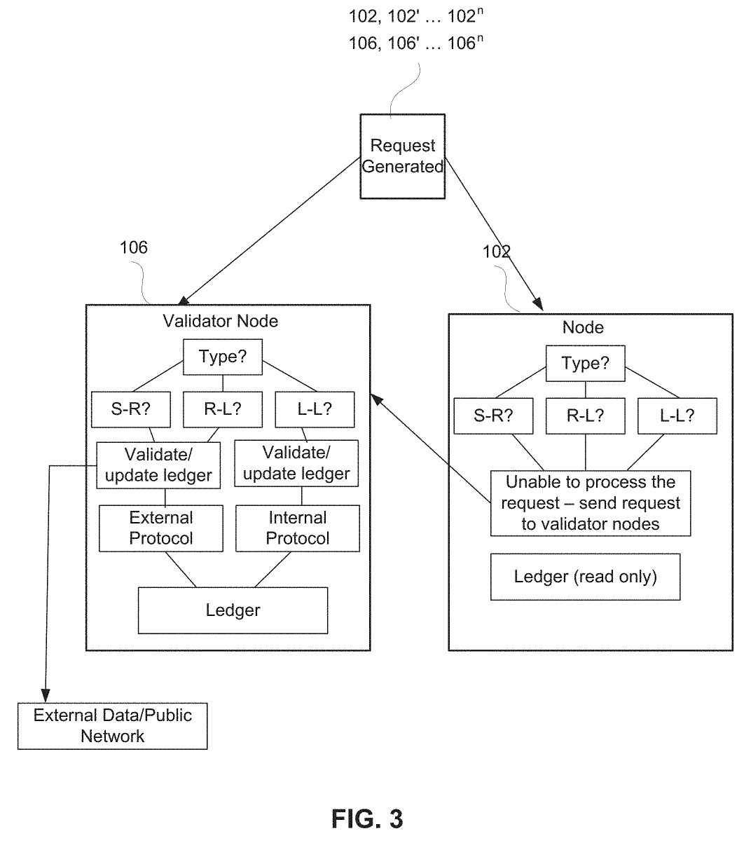

FIG. 3 shows certain process of how various requests are handled. A request is generated by one of the nodes 102/106 (which could be the same or different ones of the nodes than shown below the “request generated”. Since the request is distributed out to the network, the recipient must be one who can actually process the request. If a basic node 102 without validator capabilities receives a request, it will be unable to handle the confirmation, but this node can transfer the request to the appropriate validator node. With the proof of elapsed time model, the nodes which are actually elected to validate for particular timeframes will change in a randomized manner. It is also understood that where the validating node “validates/updates” the ledger as shown, the read only ledger on other nodes will be updated as the node would see that the ledger is old and there is a new (updated) version.

The system can be configured such that a source to root transfer may be processed by only certain validators whereas root to leaf transfers can be done by other validators and leaf to leaf can be done by still others. Typically, those who can handle source to root can handle all, but the system can be divided into three different classes of validators (nodes) with a fourth node class being a typical user with read only permissions to the various ledgers. Each class of validators may have their own ledger class to further segregate different classes and types of data. A validator node with permission for all three transfer types is shown in FIG. 3 at 106. The request is received and the type is determined. Typically, the S-R and R-L transfers will go to an external protocol for validating/updating the ledger and one ledger may be kept for these this external protocol (FIG. 3 shows a single ledger, but it is understood that multiple separate ledgers for the different transfer classes can be sued. If a L-L request is made, the internal protocol would be used without receiving data from external sources whereas the external protocol as show in FIG. 3 would rely on external data sources, especially for the S-R transfer. For clarity, the S can refer to external assets such as USD, bitcoin, litecoin or other traditional or cryptographic assets.

Therefore the system consists of three major parts, Commerce, Exchange and Liquidity. The Commerce part describes the interaction between customer and merchant. The Exchange part encompasses how different tokens can be exchanged within the system. The Liquidity part describes how the merchant user can cash in and out from the system. The whole process authenticates value creation and destruction from a common store of value, in a predictable, atomic way.

The process for token exchange in the system is stored in an authenticated tree data structure. For simplicity, consider a system where there are two tokens types, root tokens <R> and leaf tokens <L>. Without lack of generality, we can enumerate an arbitrary number of root tokens <R1>, <R2>, . . . , <RN> that each have their respective types of derivative leaf tokens. The derivative leaf tokens <L> of any root token <R> can be interchanged, but the derivative tokens of two different roots, say <L> and <L*> cannot. We explain the processes associated with the movement of leaf tokens in the Commerce section, but in a nutshell it governs the transfer of an amount of leaf token <L> from one balance to another.

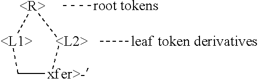

In this (simplified) representation, L1 and L2 are two different user's Leaf token <L> balances that are derived from a root token <R>. Tokens in the figure above are being transferred from <L1> to <L2>.

These leaf tokens are created a process called ‘minting’, which renders an amount (at a certain exchange rate) of the source token <R> unusable throughout the lifetime of the leaf tokens <L>. At any point, a Leaf token balance can be ‘melted’ back into the corresponding amount of Root tokens <R>, destroying the proportional amount of balance of leaf tokens <L>. The process is authenticated, in that only authorized parties can execute these processes, as well as transparent, in that any party can inspect and verify the exchange rate, authenticity, or atomicity of the exchange. This process is described in more detail in the Exchange section.

This structure can be extended with new layers that add/create value for the root tokens <R>. Consider an external source of value, we use Source token <S> to be consistent. In the Liquidity section, we describe how to ‘bridge’ value from an external source using a bridge and how value can be verifiably derived from such a source <S>.

The figure below illustrates the relationship of the different tokens and the processes that connect them in the context of the trie data structure. We remind the read that this can be generalized to accept any number of source tokens <S>, to create any number of root tokens <R> and their derivative leaf tokens <L>.

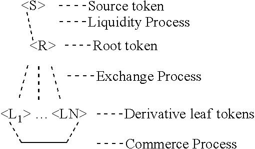

The commerce layer governs the process of transferring an amount of leaf token from one balance to another. This process verifies a number of things (a) that both leaf token balances exist; (b) that the source of the transfer has a sufficient amount of the leaf token; (c) that the entity attempting to initiate this transfer has authority to do so by providing a valid digital signature; (d) that the amount being moved out of one balance is equal to that being moved into the destination balance; and (e) that the lead tokens being transferred are the same type, that is that they are derived from the same root token <R>.

In some applications of the commerce layer, this process is curated by a single entity on behalf of many. In these cases, this entity we call a Curator <C> manages the balances of their user <U> and authenticates users via other means. Upon authorization, the curator <C> provides the necessary digital signature to transfer funds as specified above.

The curator might authenticate a user <U> in a number such as those outlined in this non exhaustive list: OAuth, two factor authentication (2FA), passwords or personal identification number, hardware device such as a mobile phone.

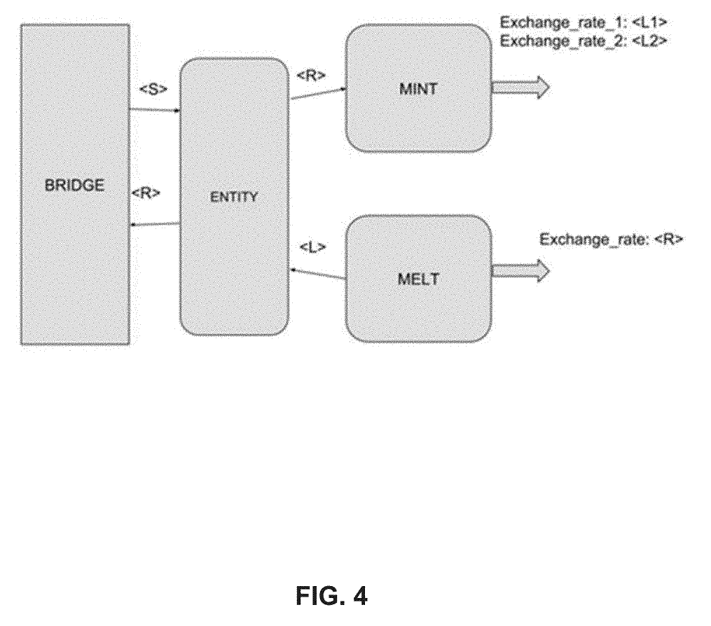

The exchange layer comprises of two main functions between different assets in our ecosystem, ‘MINT’ and ‘MELT’. See FIG. 4. They are used by the entities handling them to convert them from one form to another depending on the access control given to the entity. If token of type <R> (eg: MCG) is used as a higher valued token compared to type<L> (eg:MCC), then: 1-′MINT functionality allows us to convert tokens of type <R> to <L>. (in theory, a higher valued token to a lower valued token, however asset values may be the same, but would have different purposes/uses). ‘MELT’ functionality allows us to convert <L> to <R>. (in theory, a lower valued token to a higher valued token however asset values may be the same, but would have different purposes/uses).

The entities holding different types of assets have different ‘roles’/different levels of access control to use these functionalities. There is always an exchange rate when one type of asset is converted to another. In a real world example, a merchant/business might be allowed to have ‘MINT’ functionality but not a customer only dealing with the leaf token. This Exchange layer then talks to the liquidity layer/bridge, to convert from the internally used asset types to more widely asset source of type <S> (eg: USD, or a stable coin).

It is understood herein that for all tokens described, partial tokens can be equally used. In the bitcoin example, one satoshi is currently the smallest unit of bitcoin traded, thus one satoshi could be considered a token or part of a token equally. Likewise, one L token could be equivalent to 1 usd and smaller tokens could be fractions of a dollar in that fractions of L can be exchanged as tokens or may equally considered partial tokens.

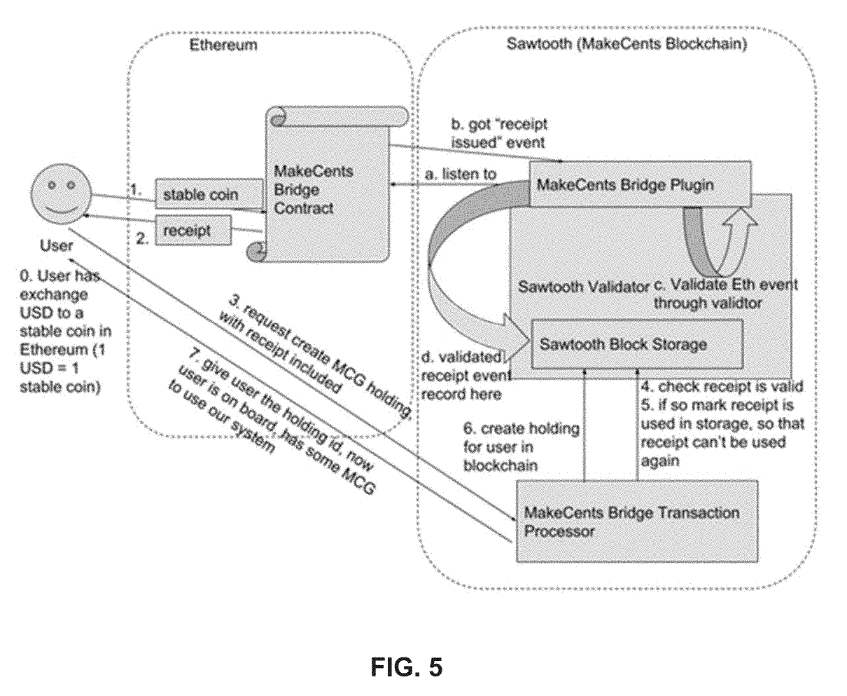

In the liquidity process the general workflow of user cash in is described by FIG. 5. The “User” in this diagram currently only support merchant user. In general, the customer user deals only with their leaf token balance <L> increasing and decreasing as they build and spend their balance. In some cases, the customer might accumulate a large balance and wish to exchange it for an external asset. In this case, it is possible for them to exchange it for a root asset <R> through the Exchange layer of MakeCents system. then cash out in Liquidity layer, but this is usually rare.

To cash in, the user needs to prepare an Ethereum wallet that they can obtain some stable coin. This step can be fulfilled by 3rd party, cryptocurrency exchanges that support Ethereum and is considered not as part of our system. The user start the cash in process by sending some amount of stable coin to Bridge Contract. This amount of stable coin then get locked by the co-signature of user and the system and only after they co-signed it can be unlocked. Therefore during this money locked, neither us and the user alone can't move these stable coins. Thus we can guarantee the amount of USD within the system Platform is always determined and correct.

Once it gets locked, user will obtain a receipt which they include in the request to the System to create a root holding. The System will confirm the validity of the receipt and create MCG holding, return back to user.

To ensure the system always has up to date Ethereum side status to determine the validity of receipts, a Bridge Plugin (processor) is used, which, in the background listens to event that generated by Ethereum side Bridge Contract, get the event updated through the validator network, and then put into sawtooth storage. After that's done, all of the applications on sawtooth side will have up to date, validated “receipt issued” information coming from the bridge contract.

The cash out process, which the reverse of the above diagram happens, except in the last step is a little different: Bridge Transaction provides a receipt confirms that user's R holding cash out request is valid and proof of certain amount of R deducted from user's holding. With this receipt as part of the signature and the signature together from user, they can unlock the equivalent amount of Ethereum stable coin from Bridge Contract. By now user finishes cash out R to Ethereum stable coin.

What is claimed is:

1. A system providing a private blockchain with decentralized external gateway into the private blockchain.
a plurality of computer nodes in communication over a private network and executing one or more software packages and keeping a ledger;
a first set of the plurality of computer nodes being validator nodes and executing a validator software package having at least one of first and second processor protocol software packages;
a second set of the plurality of computer nodes;
a first set of tokens;
a second set of tokens which are derived from said first set of tokens;
at least one of the plurality of nodes transmitting a request to the private network to transfer one or more tokens or parts thereof from a public network via a first processor protocol, the request transmitted to two or more of the first set of the plurality of computer nodes;
at least one of the two or more of the first set of the plurality of computer nodes validating the transfer and updating the ledger to generate a confirmation;
remaining ones of the two or more of the first set of the plurality of computer nodes validating the confirmation in the ledger;
wherein the ledger is updated by validator nodes such that the at least one of the plurality of nodes which transmitted the request shows at least some of the first set of tokens based on the transfer;
a second processor protocol receiving a transfer request via the private network from at least one of the plurality of nodes to convert at least some of the first set of tokens into at least some of said second set of tokens.

2. The system of claim 1 wherein the first processor protocol receives data from both external and internal sources of data, the external source of data being a public blockchain ledger.

3. The system of claim 2 wherein the second processor protocol receives data only from internal sources of data.

4. The system of claim 1 wherein the two or more of the first set of the plurality of computer nodes are selected based on a time period having not expired.

5. The system of claim 4 wherein the at least one of the two or more of the first set of the plurality of computer nodes is a fastest of the two or more of the first set of the plurality of computer nodes to validate the transfer.

6. The system of claim 5 wherein the fastest of the two or more of the first set of the plurality of computer nodes receives a fee in the form of a token selected from the first set of tokens or the second set of tokens for validating the transfer.

7. The system of claim 1 wherein the one or more validation software packages for the first set of the plurality of nodes including software for supporting the first processor protocol and the second processor protocol.

8. The system of claim 8 wherein the one or more validation software packages for the second set of the plurality of nodes includes software for supporting the second processor protocol and not for supporting the first processor protocol.

9. The system of claim 1 wherein the first processor protocol utilizes data from the private and public network for creation of one or more or part thereof of the first set of tokens and the second processor protocol utilizes data from only the private network for creation of one or more of or part thereof of the second set of tokens.

10. A node with a validation software package for a decentralized gateway to a private blockchain comprising:
a first node being a computer executing a validator software package having at least one of first and second processor protocol software packages;
said first node receiving a request to transfer one or more tokens or parts thereof from a public network via a first processor protocol;
the first node validating the request and the transfer source to generate and generating a confirmation;
the first node comparing the confirmation to a ledger containing a plurality of hashes to determine if the confirmation contains a hash present on the ledger;
if the confirmation contains a hash not present on the ledger, the first node updating the ledger with the confirmation;
if the confirmation a hash present on the ledger, the first node verifying the hash present on the ledger with the confirmation generated;
wherein, upon the ledger containing the hash associated with the confirmation, one node associated with the request being further indicated as having a root token requested by the request;
the first node receiving a request via a private network to validate a conversion of root token to leaf token and via a second processor protocol, the first node generating a confirmation.

11. The system of claim 10 wherein the first processor protocol utilizes data from the private and public network for creation of one or more or part thereof of the first set of tokens and the second processor protocol utilizes data from only the private network for creation of one or more of or part thereof of the second set of tokens.

12. The system of claim 10 wherein the first processor protocol receives data from both external and internal sources of data, the external source of data being a public blockchain ledger.

13. The system of claim 12 wherein the second processor protocol receives data only from internal sources of data.

14. The system of claim 10 wherein prior to the first node validating the request, the first node determines if a time period is active such that the first node is permissioned to validate the request.

15. The system of claim 14 wherein if the time period is not active, the first node transfers the request to a different node for which the time period is active.

16. The system of claim 14 wherein if the time period is active, the first node generates the confirmation.

17. The system of claim 15 wherein the request is transferred to the different node via another node.

18. A method of providing a decentralized gateway to a private blockchain comprising:
providing a plurality of computer nodes in communication with each other over a private network, the plurality of computer nodes executing one or more software packages and keeping a ledger;
a first set of the plurality of computer nodes being validation nodes and receiving requests to convert source tokens to root tokens;
the first set of the plurality of computer nodes generating confirmations for updating a ledger wherein a first one of the first set of the plurality of computer nodes to generate the confirmation, modifies the ledger with the confirmation and others of the first set of the plurality of computer nodes verify the modification;
two or more of the first set of the plurality of computer nodes receiving a request to convert root tokens to leaf tokens and the two or more of the first set of the plurality of computer nodes generating a confirmation which modifies the ledger.

19. The method of claim 18 wherein the request is generated by a user associated with one of the plurality of computer nodes.

20. The method of claim 18 wherein the first set of the plurality of computer nodes and the two or more of the first set of the plurality of computer nodes include different ones of the plurality of computer nodes.
